(19) United States
(12) Patent Application Publication
(10) Pub. No.: US 2014/0266088 A1
(43) Pub. Date: Sep. 18, 2014

(54) VOLTAGE REGULATOR CIRCUIT WITH CONTROLLED VOLTAGE VARIATION

(71) Applicant: KABUSHIKI KAISHA TOSHIBA, Tokyo (JP)

(72) Inventor: Eiichi MAKINO, Yokohama-shi (JP)

(21) Appl. No.: 13/961,810

(22) Filed: Aug. 7, 2013

Related U.S. Application Data
(60) Provisional application No. 61/785,717, filed on Mar. 14, 2013.

(51) Int. Cl. H02M 3/158

(52) U.S. Cl. CPC H02M 3/158
USPC 323/266

(57) ABSTRACT

According to one embodiment, a voltage regulator circuit includes a first regulator, and a second regulator. The first regulator includes a first transistor of a first conductive type, which outputs a second voltage that is generated from a first voltage and lower than the first voltage to an output node. The first regulator is usually operated. The second regulator includes a second transistor of a second conductive type, which outputs the second voltage generated from the first voltage to the output node. The second transistor is operated in a weak inversion region when data is input or output.

### CROSS-REFERENCE TO RELATED APPLICATIONS

This application claims the benefit of U.S. Provisional Application No. 61/785,717, filed Mar. 14, 2013, the entire contents of which are incorporated herein by reference.

### FIELD

Embodiments described herein relate generally to a voltage regulator circuit which is applied to, for example, a semiconductor apparatus including a data input/output circuit.

### BACKGROUND

A voltage regulator circuit generates a step-down voltage from an external voltage. Generally, the voltage regulator circuit is formed of a voltage-follower regulator of which a P-channel transistor is used as a driver. The regulator monitors the output voltage of the regulator, and the gate voltage of the P-channel driver is controlled in accordance with the monitored output voltage. As described above, since feedback control is performed in the voltage regulator circuit, voltage regulator circuits have low responsiveness when data input or output is started, at which a large quantity of current is rapidly consumed for a certain period. Thus, it is difficult to achieve increase in speed in voltage regulator circuits.

### BRIEF DESCRIPTION OF THE DRAWINGS

FIG. 1 is a circuit diagram illustrating a voltage regulator circuit according to a first embodiment.

FIG. 2 is a characteristic diagram illustrating the relationship between a load current and an output voltage in an N-channel regulator.

FIG. 3 is a characteristic diagram illustrating a result of simulation of the N-channel regulator.

FIG. 4 is a diagram illustrating load current/output voltage characteristics (simulation result) in an N-channel step-down circuit.

FIG. 5 is a circuit diagram illustrating a voltage regulator circuit according to a second embodiment.

FIG. 6 is a circuit diagram illustrating a voltage regulator circuit according to a third embodiment.

### DETAILED DESCRIPTION

In general, according to one embodiment, a voltage regulator circuit includes a first regulator, and a second regulator. The first regulator includes a first transistor of a first conductive type, which outputs a second voltage that is generated from a first voltage and lower than the first voltage to an output node. The first regulator is usually operated. The second regulator includes a second transistor of a second conductive type, which outputs the second voltage generated from the first voltage to the output node. The second transistor is operated in a weak inversion region when data is input or output.

As described above, since feedback control is performed in a voltage-follower regulator (hereinafter referred to as a “Pch regulator”) using a P-channel transistor as a driver, the voltage-follower regulator has low responsiveness, and cannot cope with rapid change in the load current. Thus, the output voltage largely drops in the voltage-follower regulator. These days, the data input/output speed is increasing, and a very large current is required when the data input/output circuit is operated. Specifically, as the data input/output cycle time is reduced to ½ or ¼ with increase in the speed, the charge/discharge current is increased to twice or quadruple.

In addition, in accordance with a demand for reduction in power consumption nowadays, the internal step-down potential tends to decrease, and the allowable voltage drop quantity of the output voltage for the access speed tends to decrease. In particular, Pch regulators which are applied to data input/output circuits that operate at high speed markedly have this tendency.

Nowadays, to improve the response speed, increasing a tail current of a differential amplifier is attempted. In this case, however, satisfactory improvement in characteristics is not obtained, since the current consumption is increased and increase in speed is limited.

In addition, to improve the response speed, N-channel source-follower regulators (hereinafter referred to as “Nch regulators”) using an N-channel transistor as a driver are used in some circuits. However, the output voltage greatly fluctuates in the Nch regulators, when the difference between the maximum voltage and the minimum voltage of the load is very large. When there is little load, such as during standby, a creep-up phenomenon may occur, that is, a phenomenon in which the source voltage of the Nch regulator increases to the maximum value or thereabouts. Thus, to suppress change in the load current, there is a method of supplying a bleeder current to a step-down potential node, to make a constant current continuously flow through the node. The method, however, increases current consumption. Although Nch regulators have excellent responsiveness by virtue of the above factor, it is difficult to use an Nch regulator alone in the present circumstances. In addition, since the driver of the Nch regulator has a large size, the Nch regulator has a large gate capacitance, and requires much time for switching between inactive and active.

The present embodiment is formed with a hybrid driver which includes both a Pch regulator and an Nch regulator.

In the present embodiment, the Nch regulator is operated only when data is input or output, and suppresses voltage drop, by being used together with the Pch regulator which is usually operated. Specifically, the Nch regulator has a characteristic of suppressing drop in the output voltage in the case where the load current rapidly increases, such as when data is input or output. The Pch regulator has a characteristic of coping with a slow change in the load current over a wide range. Mutually complementing the characteristics of the Nch regulator and the Pch regulator each other suppresses increase in the sizes of the regulators. In addition, since only the Pch regulator is used when the load current is low, it is unnecessary to use a bleeder current, and thus it is possible to suppress increase in current consumption.

Besides, in the present embodiment, only the Pch regulator is activated, and the Nch regulator is inactivated, in periods other than when data is input or output. This enables suppression of the creep-up phenomenon occurring when the load current is low, which is a problem of the Nch regulator.

In addition, according to the present embodiment, an N-channel transistor or a P-channel transistor is inserted in series into the N-channel driver, to shorten the time required for returning the Nch regulator from inactive to active and reduce the current consumption.

The present embodiment will be explained hereinafter with reference to drawings.

### First Embodiment

FIG. 1 illustrates a voltage regulator circuit according to a first embodiment. The voltage regulator circuit comprises a Pch regulator 11 and an Nch regulator 21. An output end of the Pch regulator 11 and an output end of the Nch regulator 21 are connected to an output node Nout of an internal voltage VDD. The output node Nout is connected to, for example, an input/output circuit of a semiconductor device (not shown).

The Pch regulator 11 is always operated. The Pch regulator 11 generates a voltage VDD by stepping down an external power supply voltage VEXT, and supplies the voltage VDD to the output node Nout. The Nch regulator 21 is operated when the load current increases and a current of the output node Nout rapidly increases, such as when data is input or output. The Nch regulator 21 suppresses drop in the voltage of the output node Nout. Specifically, the Nch regulator 21 is operated when data is input or output, generates a voltage VDD by stepping down the external power supply voltage VEXT, and supplies the voltage VDD to the output node Nout.

The Pch regulator 11 includes a P-channel MOS transistor (hereinafter referred to as a “PMOS”) 11a serving as a driver transistor, a differential amplifier 11b, and resistors R1 and R2. Specifically, the source of PMOS 11a is connected to a node, which is supplied with the external power supply voltage VEXT, and the drain of PMOS 11a is connected to the output node Nout of the voltage VDD. In addition, the drain of PMOS 11a is grounded through resistors R1 and R2, which form a monitoring circuit. A connection node between resistors R1 and R2 is connected to one input end of the differential amplifier 11b. The other input end of the differential amplifier 11b is supplied with a reference voltage Vref. An output end of the differential amplifier 11b is connected to the gate of PMOS 11a.

The Pch regulator 11 generates voltage VDD, which is obtained by stepping down the external power supply voltage VEXT by PMOS 11a, and supplies the voltage VDD to the output node Nout. The voltage VDD is monitored by resistors R1 and R2, and a voltage divided by resistors R1 and R2 is compared with the reference voltage Vref by the differential amplifier 11b. An output voltage VGP of the differential amplifier 11b is changed in accordance with a result of the comparison, and thereby the gate voltage of PMOS 11a is controlled. As described above, the voltage VDD is controlled to a fixed voltage.

On the other hand, the Nch regulator 21 includes an N-channel MOS transistor (hereinafter referred to as an “NMOS”) 21a serving as a driver transistor, a first gate controlling circuit 22 and a second gate controlling circuit 23, which control the gate voltage of NMOS 21a.

NMOS 21a is disposed in the vicinity of, for example, an input/output circuit (not shown). For example, a plurality of NMOSs are connected in parallel to form a transistor of large gate width. FIG. 1 illustrates NMOS 21a as a representative. The drain of NMOS 21a is connected to a node which is supplied with an external power supply voltage VEXT, and the source of NMOS 21a is connected to the output node Nout of the voltage VDD.

The first gate controlling circuit 22 is formed of a differential amplifier 21b, PMOSs 21c and 21d, NMOSs 21e, 21f, 21g, and 21h, and resistors R3 and R4.

The first gate controlling circuit 22 controls NMOS 21a such that NMOS 21a operate in a weak inversion region. Specifically, the first gate controlling circuit 22 controls the voltage of NMOS 21a, such that the gate voltage VGN of NMOS 21a is set to the set output voltage VDD when a supposed load current flows. The gate voltage VGN is set such that NMOS 21a falls within a subthreshold region when the set voltage VDD is output.

In the first gate controlling circuit 22, NMOSs 21g and 21h and resistors R3 and R4 monitor the gate voltage of NMOS 21a. Specifically, NMOSs 21g and 21h and resistors R3 and R4 are connected in series between the node, which is supplied with the external power supply voltage VEXT, and the ground. The gate electrode of NMOS 21g is connected to the gate electrode of NMOS 21a, and the gate electrode of NMOS 21h is connected to a connection node between NMOS 21g and NMOS 21h. A connection node between resistors R3 and R4 is connected to one input end of the differential amplifier 21b. The other input end of the differential amplifier 21b is supplied with the reference voltage Vref.

PMOS 21c is connected between an output end of the differential amplifier 21c and the node which is supplied with the external power supply voltage VEXT. The gate of PMOS 21c is supplied with an enable signal ENB. PMOS 21c become conducted and supplies a fixed voltage to the output end of the differential amplifier 21b, when the enable signal ENB is made low during a period in which no data is input or output.

The gate electrode of PMOS 21d is also connected to the output end of the differential amplifier 21b. The source of PMOS 21d is connected to the node which is supplied with the external power supply voltage VEXT. The drain of PMOS 21d is connected to the gate electrode of PMOS 21a, and grounded through NMOSs 21e and 21f. The gate electrode of NMOS 21e is supplied with the reference voltage Vref, and the gate electrode of NMOS 21f is supplied with the enable signal ENB.

The second gate controlling circuit 23 is formed of an NMOS 21i and an inverter circuit 21j. In the second gate controlling circuit 23, the drain of NMOS 21i is connected to the gate electrode of NMOS 21a, and the source of NMOS 21i is grounded. The gate electrode of NMOS 21i is supplied with the enable signal ENB through the inverter circuit 21j.

In the second gate controlling circuit 23, NMOS 21i conducts and turns NMOS 21a off (inactive) when the enable signal ENB is made low during a period in which no data is input or output. Conversely NMOS 21i ceases to conduct when the enable signal ENB is made high in a period in which data is input or output. In this state, NMOS 21a is controlled by the first gate controlling circuit 22.

In the above structure, when the enable signal ENB is made low during a period in which no data is input or output, PMOS 21c is turned on. Therefore, the gate voltage of PMOS 21d is made high through PMOS 21c, and PMOS 21d is turned off. In this state, NMOS 21i is turned on, and NMOS 21a is turned off, as described above.

On the other hand, when the enable signal ENB is made high in a period in which data is input or output, PMOS 21c is turned off, NMOS 21f is turned on, and NMOS 21i is turned off. NMOS 21e is turned on by the reference voltage Vref. NMOS 21e functions as a constant current circuit, and the voltage VGN is supplied to the gate of NMOS 21a through PMOS 21d. The voltage VGN is set such that NMOS 21a has subthreshold voltage when the set voltage VDD is output. The voltage VGN is monitored by NMOSs 21g, 21h, and resistors R3 and R4, and the voltage divided by resistors R3 and R4 is compared with the reference voltage Vref by the differential amplifier 21b. The gate voltage of PMOS 21d is controlled by the output voltage of the differential amplifier 21b, and the gate voltage of NMOS 21a is controlled to the subthreshold voltage. Thus, NMOS 21a is controlled to operate in a weak inversion region.

FIG. 2 and FIG. 3 illustrate operation of the NMOS at the subthreshold voltage (weak inversion region). FIG. 2 illustrates characteristics of the load current and the output voltage in the Nch regulator, and FIG. 3 illustrates a result of simulation of characteristics of the load current and the output voltage in the Nch regulator.

As illustrated in FIG. 2 and FIG. 3, in the case of using an NMOS which operates in a normal strong inversion region, the NMOS is entirely turned on, and a channel is formed in the NMOS. Thus, when the load current is increased ten times, for example, from 10 mA to 100 mA, the voltage between the gate and the source is changed by about 2 V.

In comparison with this, in the present embodiment, the gate voltage is controlled to the subthreshold voltage by the first gate controlling circuit 22, and NMOS 21a operates in the weak inversion region. Therefore, the voltage between the gate and the source of NMOS 21a changes only by 80 mV, even when the load current is increased ten times, for example, from 10 mA to 100 mA. Thus, it is unnecessary to monitor the output voltage of NMOS 21a serving as driver or feedback it to the gate voltage, and it is possible to perform high-speed response to fluctuations in the load.

FIG. 4 illustrates an example of change in the voltage VDD when data input or output is started in the Pch regulator 11.

As illustrated in FIG. 4, when data input or output is started, in a state where the output voltage VDD of PMOS 11a is low, the voltage of the Pch regulator 11 is detected by resistors R1 and R2, the detected voltage is compared with the reference voltage Vref by the differential amplifier 11b, and the gate electrode of PMOS 11a is controlled by the output voltage VGP of the differential amplifier 11b. As described above, after the output voltage VDD of PMOS 11a decreases when data input or output is started, the Pch regulator 11 operates to change the voltage VDD to the set value, by feeding back the monitor voltage and controlling the gate voltage of PMOS 11a. Thus, much time is required until the voltage VDD returns to the set voltage.

However, according to the present embodiment, the Nch regulator 21 operates when data input or output is started, and thereby a decrease in the output voltage of the Pch regulator 11 is compensated with the output voltage of the Nch regulator 21. Thus, it is possible to suppress decrease in the voltage VDD in the output node Nout.

According to the first embodiment described above, the output node Nout is connected with the Pch regulator 11 and the source-follower Nch regulator 21 using NMOS 21a as driver, the Pch regulator 11 is always operated, and the Nch regulator 21 is operated only when the load current largely changes, such as when data is input or output. Thus, decrease in the output voltage VDD can be rapidly suppressed by the Nch regulator 21, even when the load current rapidly increases. In addition, in normal operation, the voltage VDD can be output over a wide range for a slow change in the load current, by the Pch regulator which is always operated. So, it is possible to form a voltage regulator which provides high-speed response and suppresses increase in current consumption, by mutually compensating the characteristics of the Nch regulator and the Pch regulator with each other.

In addition, by forming a hybrid voltage regulator using both the Nch regulator and the Pch regulator, it is possible to form a voltage regulator circuit of a smaller size than that in the case of using Nch regulator 21 and Pch regulator 11 separately from each other.

Besides, according to the first embodiment, when the load current is low in a period other than the period in which data is input or output, only the Pch regulator 11 is activated, and the Nch regulator 21 is made inactive. This structure suppresses the creep-up phenomenon occurring in the case where the load current is low, which is a problem of the Nch regulator 21.

### Second Embodiment

FIG. 5 illustrates a voltage regulator circuit according to a second embodiment. In FIG. 5, constituent elements which are the same as those in the first embodiments are referred to by the same respective reference numerals, and only different elements are explained.

As described above, NMOS 21a serving as a driver of the Nch regulator 21 is a transistor which is operated in a weak inversion region and has large gate width, to suppress fluctuations in the voltage caused by change in the load current. Thus, it is necessary to charge/discharge a large gate capacitance, when NMOS 21a is activated or inactivated by controlling the gate voltage of NMOS 21a. So, it is necessary to secure time necessary for switching NMOS 21a between active and inactive, and secure a charge/discharge current.

To solve the above problem, in the second embodiment, an NMOS 31 is connected to an NMOS 21a in series. Specifically, NMOS 31 is connected between NMOS 21a and an output node Nout, and the gate of NMOS 31 is supplied with the enable signal ENB.

The connecting position of NMOS 31 is not limited to the part between NMOS 21a and the output node Nout, but NMOS 31 can be connected between a node, which is supplied with an external power supply voltage VEXT, and NMOS 21a.

As described above, NMOS 31 is connected in series to NMOS 21a serving as a driver, and NMOS 31 is controlled by using the enable signal ENB. Thereby, it is possible to separate the external voltage VEXT from the output node Nout. Since NMOS 31 functions as a switch, and NMOS 31 is operated in a strong inversion region, unlike NMOS 21a. Thus, the size (gate width) of NMOS 31 can be made much smaller than that of NMOS 21a. It is thus possible to achieve high-speed switching operation and low charge/discharge current.

According to the second embodiment described above, NMOS 31 which operates in a strong inversion region is connected to NMOS 21 serving as a driver in series, and NMOS 31 is controlled by using the enable signal when data is input or output. Thus, it is possible to shorten the time necessary for returning the Nch regulator 21 from inactive to active.

In addition, since it is unnecessary to discharge the gate capacitance of NMOS 21a when NMOS 21a is inactive, NMOS 21i and the inverter circuit 21j can be removed. It is thus possible to reduce the circuit area.

Besides, when NMOS 21a is inactive, it is unnecessary to discharge the gate capacitance of NMOS 21a. Thus, when NMOS 21a is switched from inactive to active, it is unnecessary to charge/discharge the large gate capacitance of NMOS 21a, and high-speed operation is achieved.

In addition, when NMOS 21a is connected to the output node 21a as in the first embodiment, it is required to provide a bleeder resistor and a bleeder current for suppressing the creep-up phenomenon of NMOS 21a. However, the output current of NMOS 21a can be suppressed to fall within a fixed load current range, by connecting NMOS 31 to NMOS 21a in series, as in the second embodiment. It is thus possible to omit the bleeder resistor and a bleeder current for suppressing the creep-up phenomenon of NMOS 21a.

### Third Embodiment

FIG. 6 illustrates a voltage regulator circuit according to a third embodiment, in which constituent elements which are the same as those in the first and second embodiments are denoted by the same respective reference numerals.

In the second embodiment, NMOS 31 is connected to NMOS 21a serving as a driver in series.

In comparison with this, in the third embodiment, a PMOS 41 is connected to an NMOS 21a in series. PMOS 41 is connected between NMOS 21a and an output node Nout, and the gate electrode of PMOS 41 is supplied with the enable signal ENB through the inverter circuit 42. A back gate (substrate) of PMOS 41 is supplied with an external power supply voltage VEXT. PMOS 41 is operated in a strong inversion region, by using the inverted enable signal ENB.

The connecting position of PMOS 41 is not limited to the part between NMOS 21a and the output node Nout, but PMOS 41 can be connected between a node, which is supplied with the external power supply voltage VEXT, and NMOS 21a.

According to the third embodiment, PMOS 41, which is operated in the strong inversion region, is connected to NMOS 21a serving as a driver in series, and PMOS 41 is controlled by using the enable signal when data is input or output. Thus, the third embodiment can obtain the same effect as that of the second embodiment.

In addition, according to the third embodiment, since the Nch regulator 21 is controlled by using PMOS 41, it is possible to prevent the voltage VDD from decreasing by a value of the threshold voltage of NMOS 31, which is caused when NMOS 31 is used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voltage regulator circuit comprising:
a first regulator including a first transistor of a first conductive type, which outputs a second voltage generated from a first voltage and lower than the first voltage to an output node, the first regulator being usually operated; and
a second regulator including a second transistor of a second conductive type, which outputs the second voltage generated from the first voltage to the output node, the second transistor being operated in a weak inversion region when data is input or output.

2. The circuit according to claim 1, wherein
the first transistor and the second transistor are connected to the output node.

3. The circuit according to claim 1, wherein
the second regulator comprises:
a monitoring circuit configured to monitor a gate voltage of the second transistor;
a differential amplifier configured to compare an output voltage of the monitoring circuit with a reference voltage; and
a third transistor of the second conductive type, which includes a current path having one end connected to a supply node of the first voltage, and the other end connected to the gate electrode of the second transistor, the third transistor including a gate electrode connected to an output end of the differential amplifier.

4. The circuit according to claim 3, wherein
the third transistor outputs a subthreshold voltage of the second transistor.

5. The circuit according to claim 3, further comprising:
a fourth transistor of the second conductive type which is connected between the gate electrode of the second transistor and ground, the fourth transistor being made inactive when the data is input or output.

6. The circuit according to claim 3, further comprising:
a fifth transistor of the first conductive type which includes a current path including one end connected to a supply node of the first voltage, and the other end connected to the gate electrode of the third transistor, the fifth transistor being made active when no data is input or output.

7. The circuit according to claim 3, further comprising:
a sixth transistor of the second conductive type which is connected to the second transistor in series, the sixth transistor being made active when the data is input or output.

8. The circuit according to claim 3, further comprising:
a seventh transistor of the first conductive type which is connected to the second transistor in series, the seventh transistor being made active when the data is input or output.

9. A voltage regulator circuit comprising:
a first regulator including a P-channel first transistor, which outputs a second voltage generated from a first voltage and lower than the first voltage to an output node, the first regulator being usually operated; and
a second regulator including an N-channel second transistor, which outputs the second voltage generated from the first voltage to the output node,
the second regulator comprising:
a monitoring circuit configured to monitor a gate voltage of the second transistor;
a differential amplifier configured to compare an output voltage of the monitoring circuit with a reference voltage; and
a third transistor of a second conductive type, which includes a current path including one end connected to a supply node of the first voltage, and the other end connected to a gate electrode of the second transistor, the third transistor including a gate electrode connected to an output end of the differential amplifier and outputting a subthreshold voltage of the second transistor.

10. The circuit according to claim 9, further comprising:
a fourth transistor of the second conductive type which is connected between the gate electrode of the second transistor and ground, the fourth transistor being made inactive when the data is input or output.

11. The circuit according to claim 9, further comprising:
a fifth transistor of a first conductive type which includes a current path including one end connected to a supply node of the first voltage, and the other end connected to the gate electrode of the third transistor, the fifth transistor being made active when no data is input or output.

12. The circuit according to claim 9, further comprising:
a sixth transistor of the second conductive type which is connected to the second transistor in series, the sixth transistor being made active when the data is input or output.

13. The circuit according to claim 9, further comprising:
a seventh transistor of the first conductive type which is connected to the second transistor in series, the seventh transistor being made active when the data is input or output.
